(19) United States
(12) Patent Application Publication
(10) Pub. No.: US 2014/0041972 A1
(43) Pub. Date: Feb. 13, 2014

(54) VOLUMETRIC BRAKING DEVICE

(71) Applicants: Jung-Soo Kim, Bucheon-si (KR); Kyung Mo Cho, Seongnam-si (KR)

(72) Inventors: Jung-Soo Kim, Bucheon-si (KR); Kyung Mo Cho, Seongnam-si (KR)

(21) Appl. No.: 14/111,579

(22) PCT Filed: Apr. 13, 2012
(86) PCT No.: PCT/KR2012/002844

§ 371 Date: Oct. 14, 2013

(30) Foreign Application Priority Data
Apr. 13, 2011 (KR) 10-2011-0034094

(51) Int. Cl. F16D 49/00

(52) U.S. Cl. CPC F16D 49/00
USPC 188/74

(57) ABSTRACT

A volumetric braking device includes: a brake disk having an outer surface where a plurality of disk vanes are formed with a predetermined spacing therebetween; a cylinder case where the brake disk is arranged, and the internal space of a cylinder is sectioned into a plurality of spaces by the disk vanes; a piston-drive unit, which has a piston roller sliding on the brake disk, and where the compressed pressure resistance generated between the piston roller and any one disk vane and vacuum pressure resistance generated between the piston roller and another disk vane operate as a braking load for the brake disk to perform decelerating and braking operations; a drive motor, which receives an electrical signal from an ECU by a program to operate in a forward or reverse direction; and a drive unit operating module for operating the piston-drive unit by operating the drive motor.

### TECHNICAL FIELD

The present invention relates to a volumetric braking device, and in particular, to a volumetric braking device in which a compression resistance within a cylinder generated between a piston and a disk vane and a vacuum resistance within the cylinder generated between the piston and the disk vane are applied to a brake disk as a braking load, thereby conducting decelerating and braking operations.

### BACKGROUND ART

Braking devices used as a universal driving body are classified into a brake disk type and a drum type.

These devices are configured such that a frictional material such as a pad mounted on a non-driven shaft applies friction to a brake disk or a drum which is a rotation member connected to a rotation body while being rotated to be rotated together with the rotation body, thereby conducting a braking operation.

However, both the brake disk type and the drum type have environmental problems such as dust caused by frictional abrasion between solid members, high temperature deterioration, noise generation, weak braking force, and generation of pollution caused by scattering of asbestos, metal or the like.

In addition, hydraulic pump type power steering which saves a driver's trouble when performing steering with the aid of the power of an engine is in the course of being changed to electric power steering through a period of transition of electric-hydraulic type power steering with the development of technologies.

A drive-by-wire technology is expected to rapidly supersede mechanical connection of individual sections in vehicles in the future.

However, a brake system which is widely used at present is an analog type.

Such the analog type brake system has a lot of parts which are mechanically engaged with each other to the extent that even a movement of a foot toe is connected to braking and are much more complicated than an accelerator or a steering system.

This has been the reason why the digitalization of brake system is delayed.

Recently, research for braking devices has been actively performed according to the development of the field of automobile. However, braking devices other than friction type braking devices have not yet been developed until now.

The existing braking devices (hydraulic type and friction type) have environmental problems such as dust caused due to frictional abrasion, high temperature deterioration, noise generation, weak braking force, pollution due to scattering of asbestos, metal or the like, and periodic replacement due to wear and tear.

With development of technologies, moving means become gradually faster and faster with digitalization (for example, an express train running at a speed of about 300 Km or the like). However, braking devices are still of the analog type and have reached the technical limits of the existing methods although various mechanical devices are added for the purpose of functional improvements. As a result, there is a problem in that the improvement effect is imperceptible as compared to investment.

In addition, the existing hydraulic or friction type braking devices suffer from irregular variation of braking force depending on the period of use, braking time, environment or the like due to frictional abrasion and fade phenomena or the like. Thus, it is difficult to prepare programs for the braking devices (data cannot be determined).

In addition, in the braking devices, a tandem booster and a brake master cylinder should be designed to suit a brake capacity that is required by a vehicle. Further, because respective vehicles are different from each other in specification, it is natural that the kinds of brakes are increased due to the lack of compatibility. Further, when a novel vehicle is developed, a braking device for the vehicle should also be designed. Accordingly, a problem of increasing the manufacturing costs is presented.

Meanwhile, as the speed of a vehicle is increased, this time at which a driver can react to visual cues is drastically reduced. As a result, a driver's ability to drive safely is greatly impaired. Accordingly, as the speed of the vehicle is increased, it becomes difficult for the driver to clearly recognize an obstacle or to find danger.

Due to this, accidents related to unexpected appearance of wild animals on a road increase. In order to alleviate the problems as described above, what is required is an artificial intelligence type braking device capable of minimizing fatal accidents and loss of life by rapid braking and immediate operation of the braking device immediately upon recognition, informing a sensed result upon sensing by using a sensor device, and operating an automatic braking device by a sensor at close proximity.

However, with the existing braking devices (hydraulic or friction type), there is a problem in that the number of complicated mechanical parts is increased and as a result, material costs are increased in order to apply the functions as described above. Thus, a braking device has been requested that may be combined with various sensors (e.g., a sensor for sensing a distance to a front object) to be capable of combining various functions (e.g., a front object sensing mode, a rainy road mode, a snowy road mode, a turn mode, etc.) only with a programming operation without needing additional mechanical devices.

Meanwhile, in a device for transporting a high weight (e.g., an elevator), a brake is designed separately for a high speed section and a low speed section during transportation due to inertia force. Since it is directly associated with productivity, the low speed section is configured as short as possible in a factory or the like, which may put undue strain on the brake. Accordingly, there is a problem in that the life span of the brake is reduced and the machine should be stopped during the replacement of a brake pad.

### DETAILED DESCRIPTION OF THE INVENTION

### Technical Problem

The present invention has been made in order to solve the problems as described above and an object of the present invention is to provide a volumetric braking device which is configured to operate a drive unit through a drive motor or an electromagnetic value by receiving an electrical signal of an electronic control unit (ECU) by a program so that the volumetric braking device is suitable for digitalization.

Another object of the present invention is to provide a braking device in which a piston is provided at each of front and rear sides of a brake disk casing of the braking device, a drive unit is operated by a drive motor or an electromagnetic valve so that two piston rollers are moved to be in contact with a brake disk and disk vanes so that a condition capable generating a braking load using a volume change is developed and a compressing pressure resistance and a vacuum pressure resistance due to the volume change between the top side and bottom side vanes with reference to the center of each of the piston are applied to the brake disk as a braking load, thereby conducting deceleration and braking operations.

Still another object of the present invention is to provide a braking device in which a low speed section may be configured to be shorter than that of an existing friction type brake so that when the braking device is provided in a factory or the like, the productivity can be considerably improved.

### Means for Solving the Problems

In order to achieve the objects as described above, there is provided a volumetric braking device including: a brake disk having an outer surface on which a plurality of disk vanes are formed with predetermined spacing therebetween; a cylinder case in which the brake disk is arranged, and the internal space of a cylinder is sectioned into a plurality of spaces by means of the disk vanes; a piston drive unit, which has a piston roller sliding on the brake disk, and in which the compressed pressure resistance generated between the piston roller and any one disk vane and vacuum pressure resistance generated between the piston roller and another disk vane operate as a braking load for the disk brake to perform decelerating and braking operations; a drive motor, which receives an electrical signal from an ECU by means of a program in order to operate in a forward or reverse direction; and a drive unit operating means for operating the piston-drive unit by operating the drive motor.

The piston drive unit may include: a piston cylinder moved by the operation of the drive motor; a piston installed in front of the piston cylinder and moved by and together with the piston cylinder; a piston cylinder interposed in front of the piston and contacted with and moved on the brake disk so as to generate the braking load; a piston spring mounted between the piston cylinder and the piston to elastically support the piston spring; a casing coupled to the cylinder case and configured to accommodate the above-described components; and a holder installed inside of the casing in such a manner that an oil passage is formed between the holder and the casing.

In the present invention, the piston drive unit may be installed on each side of the cylinder case so that when the piston drive units are operated, two piston rollers may be contacted with and moved on the brake disk and the disk vanes, thereby generating the braking load by the volume change.

Each of the disk vanes may be formed in a triangle shape having a smooth curve in relation to the brake disk so that the piston roller may be smoothly rotated without receiving resistance.

In addition, three disk vanes may be arranged at a 120 degree interval on the outer circumference of the brake disk in order to prevent the brake disk from becoming eccentric when rotating.

The filler within the cylinder case may be configured by any one selected from an incompressible oil, various gases and a combination thereof.

The piston drive unit may be provided with a pressure discharge valve configured to bypass a pressure over a limit pressure so as to prevent the damage of the braking device.

A check valve may be installed between the pressure discharge valve and the piston roller, and the charge which has passed the check valve may be bypassed after it is introduced into the cylinder where a vacuum pressure is formed through the bypass passage

The oil passage formed between the casing and the holder may be provided with a check valve so as to prevent the oil introduced into the oil passage from flowing backward.

The volumetric braking device may further include a disk motor which is coupled to the brake disk and may be used as a main power device or an auxiliary power device.

Here, the disk motor may have a rotator constituted by a coreless motor and a stator configured in the cylinder case.

Meanwhile, the cylinder case may be provided with an inlet configured to introduce a filler into the cylinder.

In the present invention, the drive unit operating module may include: a ball bearing screw connected to the motor shaft of the drive motor and a coupling; a grip formed with grip threads engaged with drive threads of the ball bearing screw; and a guide block connected with the grip to be linearly moved.

In the present invention, the piston may be formed with an oil passage and the piston cylinder may be formed with an oil passage so as to facilitate the movement of the piston cylinder without using a large force for operating the driving motor when moving the piston cylinder.

The volumetric motor of the present invention may further include: a tank configured to supply hydraulic pressure or pneumatic pressure; a supply line through which the hydraulic pressure or the pneumatic pressure is supplied so as to rotate the brake disk; and a switch valve configured to open/close the supply line.

### Effect of the Invention

According to the present invention as described above, it is possible to solve the problems of the existing braking devices (hydraulic type and friction type) including environmental problems such as dust caused due to frictional abrasion, high temperature deterioration, noise generation, weak braking force, pollution due to scattering of asbestos, metal or the like, and periodic replacement due to wear and tear by configuring a braking device in a volumetric type using a volume change and to obtain an environment-friendly effect by increasing the life of the braking device.

In addition, since complicated mechanical devices of the existing braking devices (hydraulic type and friction type) is omitted and an electrical signal is used like a switch, the braking device may be installed at any desired place such as a steering wheel, a dash board or the like.

Most of all, since the braking device may be instantly operated by receiving an electrical signal, the response is considerably rapid, and since the friction wear does not occur, the braking force is always constant according to the condition. Therefore, electrical commands for operating the brake may be digitalized in an ECU in combination with various design data (in consideration of load, height, power, inertia force, use, or the like) and various sensors. Accordingly, various artificial intelligence functions may be digitalized with various sensors and programs without installing additional mechanical devices to combine functions suitable for the specifications of various vehicles.

The present invention as described above may exhibit the effects of an ABS only with programs without using an ABS unit, and may be operated in linkage with any other electronic control device.

In addition, when the inventive braking device is applied to a vehicle, four wheels may be independently controlled. Therefore, it is possible to prevent biased braking and on the contrary, possible to use the biased braking so as to adjust the brakes at a corner while turning, thereby adjusting the under-steer and over-steer.

Further, the existing brake system suffers from the reduction of a frictional coefficient and hence the reduction of braking force since the pads or linings are heated to a high temperature when the brake is frequently used on a long downhill road or at high speed driving. However, the inventive braking device does not generate such a fade phenomenon because it does not use the frictional force due to its construction.

In addition, various functions (front object sensing mode, rainy road mode, snowy road mode, turning mode or the like) may be combined in the inventive braking device only with various sensors (front object distance sensing sensor) and programs without needing additional mechanical devices.

When driving on a slippery road such as a snowy road in front wheel driving, the rear wheels are merely dragged, a skidding phenomenon which causes the vehicle to slip to one side due to the weight of the vehicle body and inertia may occur. According to the present invention, programs may be prepared such that electricity is supplied to the motor coupled to the rear wheel brake disks by the ECU program by receiving data of the weight sensing sensor to balance the left and right wheels, and the weight may be distributed to the four wheels so that the vehicle may be stably driven in any situation. Consequently, the function and performance of the vehicle may be upgraded with low costs.

The inventive volumetric braking device may be used by inputting programs to the ECU to make the braking function suitable for various kinds of vehicles to be compatibly used for various kinds of vehicles, thereby reducing the material costs (design and stock) and combining the upgraded novel braking device with the existing vehicle through a program input method.

In addition, by applying a drive motor which is operated forwardly or reversely by receiving an electrical signal of ECU by programs, the inventive braking device is suitable for digitalization.

In a high load transportation device, since a low speed section may be configured to be shorter than that of an existing friction type brake so that when the braking device is provided in a factory or the like, the productivity can be considerably improved. In addition, since it is not required to replace consumables as in frictional brakes, it is possible to solve the problem of stopping the operation of the mechanical device in order to replacing brake pads.

### BRIEF DESCRIPTION OF THE DRAWINGS

FIGS. 1A and 15 are cross-sectional views illustrating a configuration of an exemplary embodiment of the inventive braking device prior to operation.

FIG. 2 is a cross-sectional view illustrating the operation and termination of the inventive braking device according to the present invention.

FIG. 3 is a cross-sectional view illustrating the operation of the inventive braking device.

FIGS. 4 to 6 are cross-sectional views illustrating the piston roller which is contacted with and moved on a disk vane in the inventive braking device.

FIG. 7 is a cross-sectional view using a driving type braking device using an electromagnetic valve as another exemplary embodiment of the inventive braking device.

FIG. 8 is a perspective view illustrating the construction of the inventive braking device.

FIGS. 9 to 12 are cross-sectional views illustrating another exemplary embodiment of the inventive braking device, in particular, a construction of a device using a hydraulic or pneumatic motor and hydraulic pressure or pneumatic pressure supply lines.

### DESCRIPTION OF SYMBOLS

3: cylinder 10: brake disk
20: piston 21: piston roller
22: piston spring
a23: piston's lower side bypass passage
b23: piston's upper side bypass passage
a24: piston's lower side oil passage
b24: piston's upper side oil passage
a25: piston's lower side bypass passage
b25: piston's upper side bypass passage
a27: piston's lower side one-way check valve
b27: piston's upper side one-way check valve
28: piston roller bearing
30: piston pressure discharge valve
30: piston cylinder
32: piston cylinder spring
a33: piston cylinder's lower pressure remove passage
b33: piston cylinder's upper pressure remove passage
a35: piston cylinder's lower side oil passage
b35: piston cylinder's upper side oil passage
40: cylinder case
50: holder
a51: holder's lower side oil passage
b51: holder's upper side oil passage
a57: holder's lower side one-way check valve
b57: holder's upper side one-way check valve
100: a, b, c disk vanes
200: piston drive motor (stepping motor)
200′: electromagnetic valve (solenoid type driving)
210: ball bearing screw
220: grip screw 230: driving screw
240: grip
250: guide block (device configured to transfer force from the drive motor 200 to piston cylinder 30)
260: coupling 300: disk motor
310: motor rotator (magnet) 320: motor stator (coil)
400: cylinder filler (oil) inlet
410: cylinder filler (oil) outlet
500: casing 510: casing heat radiation fin
a500, b500, c500, d500: hydraulic or pneumatic line
a600, b600, c600, d600: solenoid
700: switch valve
800: tank
IN800: supply line
OUT800: hydraulic pressure recovery line

### BEST MODE FOR CARRYING OUT THE INVENTION

According to the present invention, there is provided a volumetric braking device, including: a brake disk having an outer surface on which a plurality of disk vanes are formed with a predetermined spacing therebetween; a cylinder case in which the brake disk is arranged, and the internal space of a cylinder is sectioned into a plurality of spaces by means of the disk vanes; a piston-drive unit, which has a piston roller sliding on the brake disk, and in which the compressed pressure resistance generated between the piston roller and any one disk vane and vacuum pressure resistance generated between the piston roller and another disk vane operate as a braking load for the disk brake to perform decelerating and braking operations; a drive motor, which receives an electrical signal from an ECU by means of a program in order to operate in a forward or reverse direction; and drive unit operating means for operating the piston-drive unit by operating the drive motor.

### MODE FOR CARRYING OUT THE INVENTION

Hereinafter, exemplary embodiments of a volumetric braking device according to the present invention will be described in detail with reference to the accompanying drawings.

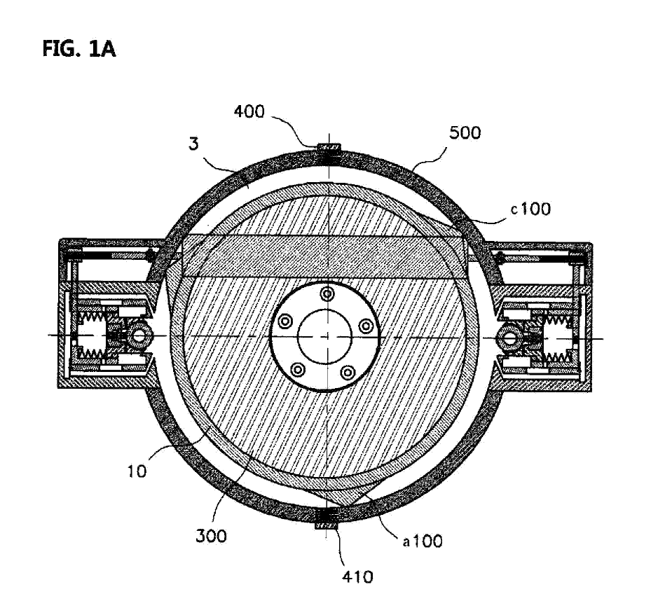

FIGS. 1A and 1B are cross-sectional views illustrating a configuration of an exemplary embodiment of a braking device according to the present invention.

The inventive volumetric braking device is provided with a brake disk 10 mounted to be integrally rotated with a wheel of a vehicle in which the brake disk 10 is formed with a plurality of disk vanes a100, b100 and c100 at a predetermined interval on the outer circumference thereof.

The brake disk 10 is installed within a casing 500 and the casing 500 includes a cylinder of which the interior is divided into a plurality of spaces by the plurality of disk vanes a100, b100, and c100.

In the present invention, the disk vanes a100, b100, and c100 are arranged at the interval of 120° on the outer circumference of the brake disk 10 so that brake disk 10 does not become eccentric when the brake disk 10 is rotated. Thus, three disk vanes of a first disk vane a100, a second disk vane b100, and a third disk vane c100 are provided.

The inventive braking device as described above includes: a piston drive unit provided with a piston roller 21 configured to slide on the brake disk 10; a piston drive motor 200 configured to receive an electrical signal from an ECU (not illustrated) by means of a program to be operated in a forward or reverse direction; and a drive unit operating module configured to operate the piston drive unit based on the operation of the piston drive motor 200.

The piston drive unit applies a braking load to the brake disk 10 by compression pressure resistance generated between the piston roller 21 and one of the disk vanes and vacuum pressure resistance generated between the piston roller 21 and another disk vane, thereby conducting deceleration and braking operations.

The piston drive unit in the present invention includes: a piston cylinder 30 configured to be moved by the operation of the piston drive motor 200; a piston 20 installed in front of the piston cylinder 30 to be moved together with the piston cylinder 30 by the piston cylinder 30; a piston roller 21 provided in front of the piston 20 and configured to slide on the brake disk 10 to generate a braking load; a piston spring 22 mounted between the piston cylinder 30 and the piston 20 to elastically support the piston 20; a cylinder case 40 coupled to the piston cylinder 30 and configured to accommodate the components described above; and a holder installed within the cylinder case 40 so that oil passages a51 and b51 are formed between the cylinder case 40 and the holder 50.

The upper and lower sides of the piston drive unit have symmetric configurations with reference to the piston 20 and various valves and oil passages are provided in the piston drive unit so that a compression function and a vacuum function crossly occur depending on the brake disk 10 to execute a braking function, in which the piston drive unit is configured such that, at the time of clockwise rotation, the lower side is applied with compression and the upper side is applied with vacuum, and at the time of counterclockwise rotation, the lower side is applied with vacuum and the upper side is applied with compression, thereby executing the braking function.

In addition, even under an unstable external environment (e.g., an uneven road surface or the like) that applies vibration, impact or the like, the piston 20 is configured to compress the brake disk 10 by a self-energizing action as long as a pressure exists within the piston cylinder 30, thereby performing its own function of the braking action based on the volume.

The piston drive unit as described above is installed at each of the opposite sides of the casing 500 so that the piston drive unit is operated by the piston drive motor 200. Thus, two piston rollers 21 slide on the brake disk 10 and the disk vanes to be capable of generating a braking load using a volume change.

This is a construction for ensuring that the braking action is continuously maintained while the brake disk 10 rotates 360 degrees. In this construction, one of the piston drive units which has the same construction as the other piston drive unit is installed at a position of 180 degrees from the other piston drive unit so that two pistons are simultaneously operated and three disk vanes are arranged at 120 degree intervals around the brake disk 10 so that the volumetric braking action by a compression/vacuum principle is performed by two pistons 20 while the brake disk 10 rotates 360 degrees. As a result, even when one piston 20 temporarily loses its braking function, the continuous braking function may be maintained by the braking action of the opposite side piston 20 while the brake disk 10 rotates 360 degrees.

It is desirable that each of the disk vanes a100, b100, and c100 has a triangular shape having a smooth curve in relation to the brake disk 10 so that the piston roller 21 may be smoothly rotated without resistance.

In the present invention, the filler within the casing 500 is preferably constituted with an incompressible oil in order to ensure a strong braking force. However, depending on the characteristics of respective braking devices, other oils, various gases, or a combination thereof may also be used.

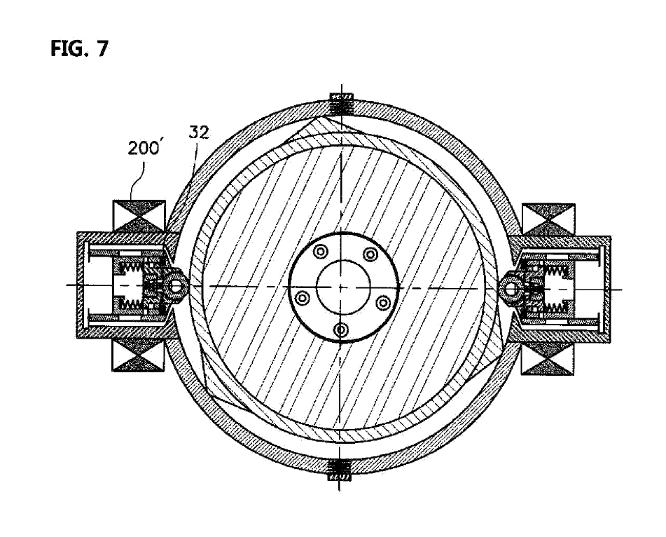

Here, the casing 500 is provided with a piston cylinder holder, a piston drive motor, and a stator of the disk motor 300. Especially, in order to dissipate the heat from the stator coil of the disk motor 300, air cooled fins 510 for heat dissipation may be provided as illustrated in FIG. 8.

In the piston drive unit of the present invention, when the speed of the vehicle is high at the time of conducting the braking function, a higher pressure and a stronger braking force in proportion to the pressure occur in the cylinder 3. By applying respective data for preventing the damage of the braking device by the compression pressure and designing each vehicle model (speed, maximum load, inertia, use and the like) with a braking distance prediction program through simulation, the mechanical limit pressure within the cylinder 3 at the time of rapid braking is analyzed and data such as a tire locking phenomenon by inertia at the time of rapid braking for each speed are determined so as to analyze a proper pressure value within the cylinder for the most stable braking for each vehicle, thereby providing a pressure discharge valve 29 which is a braking pressure stabilization device in the piston 20.

The braking device of the present invention is primarily configured to be operated for the purpose of the most safe and rapid stopping by receiving, based on an ECU program, the newest data for the current situation of a vehicle from each sensor by calculating specifications, speed or the like input for each vehicle, and secondarily, the braking device is provided with the pressure discharge valve 29 as the braking pressure stabilization device for the purpose of the safety of the vehicle when an unexpected disorder occurs or manual braking is performed. A pressure exceeding a predetermined pressure, i.e. the limit pressure mechanically endured by the braking device is bypassed so as to prevent the damage of the braking device. In order to prevent an accident by the tire locking phenomenon by inertia for each speed at the time of rapid braking, the design data for each vehicle model is applied and analyzed by applying a simulation program for each model so that the pressure discharge valve is pressure-adjusted and installed to bypass the pressure exceeding the design pressure. When it is desired to improve the performance of the braking device, two or three pressure discharge valves which have different pressure values and discharge the pressure exceeding the design pressure may be provided in parallel to each other.

For example, the inertia absorbing braking function may be conducted by bypassing the pressure exceeding the design pressure by operating three pressure discharge valves for the pressure exceeding 30 tons, two pressure discharge valves for the pressure exceeding 20 tons, one pressure discharge valve for the pressure exceeding 10 tons.

The oil pressure generated within the cylinder 3 by the braking device is adapted to be applied to the piston cylinder 30 through the oil passages a51 and b51 provided in the holder 50 and via the check valves a57 and b57, and the pressure exceeding the mechanical design pressure is adapted to be introduced and bypassed to the upper side (lower side) of the cylinder 3 with reference to the piston where a vacuum pressure is formed through the pressure discharge valve 29 of the piston 20 and via the check valves b27 and a27. As a result, the pressure within the cylinder 3 may always be maintained at a pressure which does not exceed the design pressure and an optimum braking force may be applied

Meanwhile, the check valves a27 and b27 are installed between the pressure discharge valve 29 and the piston roller 21 and the oil which has passed the check valves a27 and b27 is introduced into the cylinder where the vacuum pressure is formed and then bypassed through the bypass passages a25 and b25.

In order to prevent the oil introduced into the oil passages a51 and b51 formed between the cylinder case 40 and the holder 50 from flowing backward, check valves a57 and b57 are provided.

The inventive braking device further includes a disk motor 300 which is connected to the brake disk 10 and may be used as a main power device or an auxiliary power device.

When the motor 300 is connected to the brake disk 10, the rotator is provided on the brake disk 10, and the stator is provided in the casing 500, it is desirable to provide a coreless motor 300 so that the motor is used as the auxiliary power device and allows the brake disk 10 to be freely rotated in an internal combustion engine vehicle, and to provide a high power motor 300 so that the motor may be used as the main or auxiliary power device in an electric vehicle and a hybrid vehicle.

On a slippery road such as a snowy road, the motor 300 may be configured to conduct a four-wheel drive function only with a program without adding a mechanical device by supplying electricity thereto by the ECU program, and the motor may be configured to conduct a braking function and a charging function by being used as a power generator by a switch device.

Meanwhile, the casing 500 is provided with an inlet 400 for introducing a cylinder filler into the casing 500. An outlet 410 is provided at the opposite side to the inlet 400 so as to discharge the cylinder filler.

In the present invention, the drive unit operating module includes a ball bearing screw 210 connected to the motor shaft of the drive motor 200 and, coupling 260, a grip 240 formed with grip threads 220 engaged with drive threads 230 of the ball bearing screw 210, and guide block 250 connected to the grip 240 to be linearly moved.

In addition, in order to facilitate the movement of the piston cylinder 30 without using a large force for operating the piston drive motor 200 when moving the piston cylinder 30, the piston 20 is formed with oil Passages a24 and b24 and the piston cylinder 30 is formed with oil passages a35 and b35.

The inventive braking device configured as described above may be configured to be operated by sensing an operation point at three or more steps by sensors (switches) when the driver operates the braking pedal.

1st Step: A Mode of Weakly Pressing Down the Pedal and Operating the Pedal not More than the Set Time

The newest data for the current situation of the vehicle is collected from each sensor by the ECU deceleration program. The motor coupled with the brake disk is connected to the charging device by the switch device so as to conduct the deceleration action while charging electricity using a sacrifice braking force.

2nd Step: A Mode of Pressing Down the Pedal at Intermediate-Level and Operating the Pedal not Less than the Set Time

The newest data for the current situation of the vehicle is collected from each sensor by the ECU deceleration braking program. The motor coupled to the brake disk is connected to the charging device by the switch device so that electricity is charged by the sacrifice braking force. At the same time, two piston cylinders before and after the forward direction of the motor (operating an electromagnetic valve) are moved from the piston holders (compressing the piston cylinder springs) toward the brake disk, and the pistons are moved together with the piston cylinders by the piston cylinders and compress the piston springs. Then, the piston rollers are contacted with the brake disk to be rotated, thereby developing a condition where a braking load may be generated and, due to the volume changes of the spaces between the lower side and the upper side vanes with reference to the respective pistons by the rotation of the brake disk, the compression pressure resistance and the vacuum pressure resistance are applied to the brake disk as the braking load, thereby conducting deceleration and braking functions.

3rd Step: A Mode of Pressing Down the Pedal Deeply and Operating the Pedal Exceeding the Set Time

The newest data for the current situation of the vehicle is collected from each sensor by the ECU rapid braking operation function program. The specifications, speeds or the like input for each vehicle are calculated and the braking device is operated for the most safe and rapid stopping. The motor coupled to the brake disk is connected to the charging device by the switch device so that electricity is charged by the sacrifice braking force. At the same time, two piston cylinders before and after the forward direction of the motor (operating an electromagnetic valve) are moved from the piston holders (compressing the piston cylinder springs) toward the brake disk, and the pistons are moved together with the piston cylinders by the piston cylinders and compress the piston springs. Then, the piston rollers are contacted with the brake disk to be rotated, thereby developing a condition where a braking load may be generated and, due to the volume changes of the spaces between the lower side and the upper side vanes with reference to the respective pistons by the rotation of the brake disk, the compression pressure resistance and the vacuum pressure resistance are applied to the brake disk as the braking load, thereby conducting deceleration and braking functions.

The motor 300 coupled to the disk 10 is connected to or separated from the charging device (momentary repeated operation principle), and may conduct a fine speed adjustment function with a sacrifice braking force.

That is, upon sensing a sensor signal of a brake pad when performing a defensive driving (a female driver may frequently put her foot on and down from the pedal due to mental and habitual reasons), the ECU causes the motor 300 which is coupled to the disk 10 by the program to be connected to and separated from the charging device momentarily and repeatedly by the switch device. As the repeated times within the set time are increased, a return delay TIME function is provided to the ECU program. At this time, the motor is repeatedly connected to and separated from the charging device to perform a fine speed adjustment function with a sacrifice braking force suitable for the driver's driving habit. According to the advantage of the inventive device, the driver's mentality and habit may be programmed.

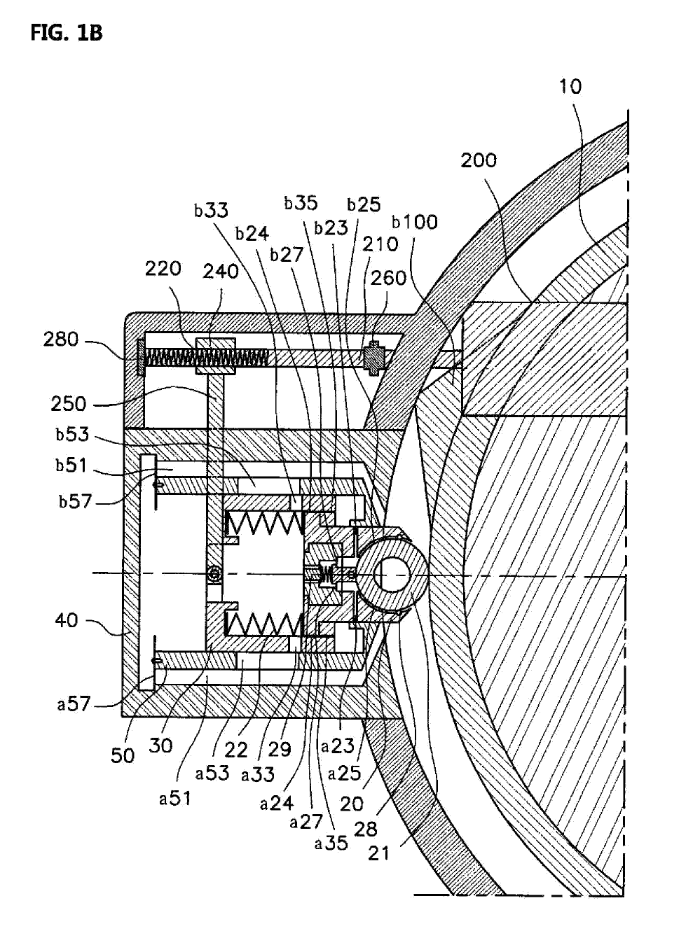

The operation of the inventive braking device when the disk is rotated clockwise will be described. The motor 300 coupled to the brake disk 10 by the ECU program as illustrated in FIG. 1 may charge electricity with sacrifice braking force by being connected to the charging device by the switch device. As illustrated in FIG. 2, when the piston drive motor 200 is operated in the forward direction, the ball bearing screw 210 connected to the coupling 260 is rotated in the forward direction and the guide block 250 connected with the grip 240 by the grip threads 220 engaged with the drive threads 230 of the ball bearing screw 210 is moved toward the brake disk 10.

In addition, the piston cylinder 30 connected to the moved guide block 250 is also moved in the same direction.

In order to facilitate the movement of the piston cylinder 30 without using the large force for operating the piston drive motor 200 when moving the piston cylinder 30, oil passages a24 and b24 are formed in the piston 20 and oil passages a35 and b35 are formed in the piston cylinder 30 so that the resistance caused by the difference of pressure of the oil generated when the piston cylinder 30 is moved may be cancelled out.

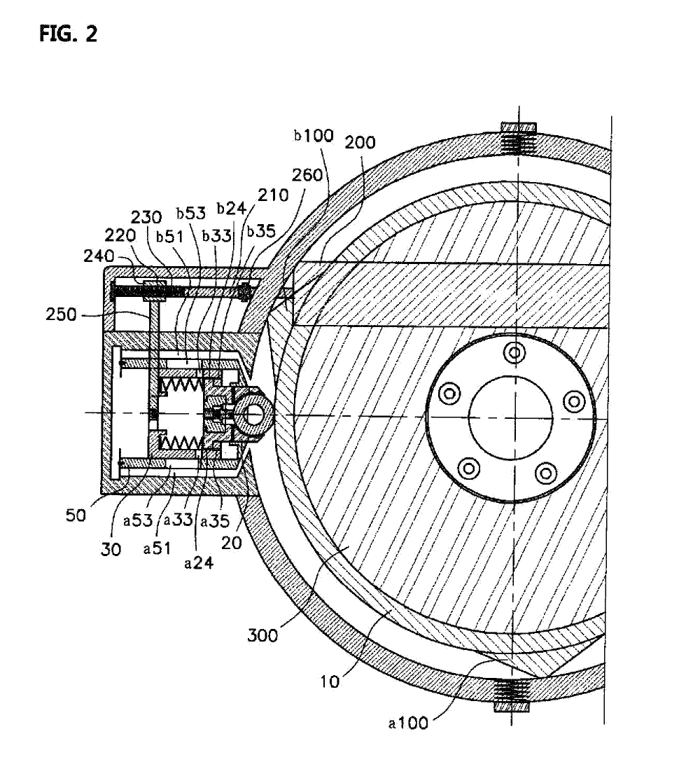

The piston 20 is also moved toward the disk 10 by the piston cylinder 30 and thus, compresses the piston spring 22, as illustrated in FIG. 3, so that the piston roller 21 is contacted to and moved on the brake disk 10, thereby developing a condition for generating the braking load. The lower side disk vane a100 with reference to the piston 20 is moved toward the piston 20 by the rotation of the brake disk 10, thereby generating oil compression resistance by the extent of reducing the volume of the cylinder. The upper side vane b100 with reference to the piston 20 is moved away from the piston 20 to increase the volume of the cylinder, thereby generating vacuum resistance.

In addition, the compression pressure within the lower side cylinder 3 with reference to the piston 20 is diffused to the inside of the piston cylinder 30 through the oil passage a51 configured in the holder 50 and via the check valve a57, and the compression pressure which is proportional to the rotation speed and the volume change acts as a force for compressing the piston 20 toward the brake disk 10, and the vacuum pressure within the upper side cylinder 3 with reference to the piston 20 acts as a force for pulling the piston 20. Accordingly, even under any unstable external environment (e.g., an uneven road surface or the like) that applies vibration, impact or the like, the piston 20 is configured to compress the brake disk 10 by a self-energizing action as long as a pressure exists within the piston cylinder 30, thereby performing its own function of the braking action based on the volume.

In addition, when the speed of the vehicle is high at the time of conducting the braking function, a higher pressure and a stronger braking force in proportion to the pressure occur in the cylinder 3. By applying respective data for preventing the damage of the braking device by the compression pressure and designing each vehicle model (speed, maximum load, inertia, use and the like) to a braking distance prediction program through simulation, the mechanical limit pressure within the cylinder 3 at the time of rapid braking is analyzed and data such as a tire locking phenomenon by inertia at the time of rapid braking for each speed are determined so as to analyze a proper pressure value within the cylinder for the most stable braking for each vehicle, thereby providing a pressure discharge valve 29 which is a braking pressure stabilization device in the piston 20.

In addition, the oil passing the bypass passages a25 and b25 of the piston 20 when conducting the braking function passes between the piston rollers 21 while performing lubrication and sealing actions so as to cancel out the frictional resistance generated on the piston rollers 21 due to the stress by the strong compression pressure.

The actions after completing the deceleration by the operation of the braking device will be described. If the driver stops a braking command by operating the brake pedal when the rotation force of the brake disk is reduced to a desired level by the compression/vacuum action according to the operation sequence, the drive motor 200 is rotated reversely by the ECU program, then the ball bearing screw 210 connected to the coupling 260 is rotated reversely, and the guide block 250 connected with the grip 240 by the grip threads 220 engaged with the drive threads 230 of the ball bearing screw 210 is moved toward the holder 50. Then, the piston cylinder 30 connected to the moved guide block 250 is also moved in the same direction (by the restoration action of the piston spring 32) while cancelling out the resistance by the pressure difference of oil which is generated when the piston cylinder 30 is moved, through the oil passages a24 and b24 of the piston 20 and the oil passages a35 and b35 of the piston cylinder 30.

As long as the compression pressure diffused into the piston cylinder 30 exists, the piston 20 is in the state in which the piston 20 compresses the brake disk 10 by the self-energizing action compressing the piston 20 toward the brake disk 10.

At this time, the passages a33 and b33 of the piston cylinder 30 are opened, and the compression pressure within the lower side cylinder 3 with reference to the piston 20 flows through the oil passage a51 formed in the holder 50, the passage a53, and the opened oil passage a33 formed in the piston cylinder 30, and is sucked into the upper side cylinder 3 with reference to the piston 20 where the vacuum pressure is formed together with the compression pressure within the piston cylinder 30 through the opened oil passage b33 and via the passage b53 of the holder 50 and the oil passage b51. Thus, the compression pressure that compresses the piston 20 is exhausted.

When there is no accelerator (acceleration pedal) operation signal and the braking device sensors sense it (1st step: state where no braking command exists but the driver's foot is put on the braking pedal), the piston cylinder 30 is maintained at the position of FIG. 2 for the purpose of an additional braking operation by the ECU program. At this time, since the passages a33 and b33 of the piston cylinder 30 are in the opened state and thus, pressure is not generated within the cylinder 3, the deceleration action by volume is terminated.

Thereafter, when the driver takes the foot away from the braking pedal and no signal exists in the braking sensor over a set time or the accelerator (acceleration pedal) is operated, as illustrated in FIG. 1, the ball bearing screw 210 connected to the reversed coupling 260 of the piston drive motor 200 by the ECU program is rotated reversely and the guide block 250 connected to the grip 240 by the grip threads 220 engaged with the drive threads 230 of the ball bearing screw 210 is moved toward the holder 50. In addition, the piston cylinder 30 connected to the moved guide block 250 is also moved in the same direction while cancelling out the resistance generated by the pressure difference of the oil generated at the time of the piston cylinder 30 through the oil passages a24 and b24 of the piston 20 and the oil passages a35 and b35 of the piston cylinder 30, and the piston 20 is returned to the holder 50, thereby terminating the deceleration action.

The motor 300 coupled to the disk 10 is separated from the charging device by the switch device and stops all the braking functions.

The stopping after braking is as follows.

When the brake disk 10 loses the rotation energy to be stopped by the compression/vacuum action according to the operation sequence, the lower side disk vanes a100 with reference to the piston 20 are moved toward the piston 20 by the rotation of the brake disk 10 to compress the oil by the extent of reducing the volume of the cylinder 3, thereby accumulating compression energy, and the upper disk vanes b100 with reference to the piston 20 are moved away from the piston 20 by the rotation of the brake disk 10 to increase the volume of the cylinder 3, thereby generating vacuum pressure.

Although the brake disk 10 is stopped by the braking action caused by the compression action and the vacuum action, the energy accumulated by the compression pressure and the vacuum pressure may act as repulsive energy to urge the brake disk 10 reversely. Thus, a wheel sensor performs sensing (stop signal sensing) by applying the program at the time of stopping.

The ball bearing screw 20 connected to the reverse coupling 260 of the piston drive motor 200 by the ECU program is rotated reversely and the guide block 250 connected to the grip 240 by the grip threads 220 engaged with the drive screw threads 230 of the ball bearing screw 210 is moved toward the holder 50. In addition, the piston cylinder 30 connected to the guide block 250 is also moved in the same direction while cancelling out the resistance generated by the pressure difference of the oil generated at the time of moving the piston cylinder 30 through the oil passages a24 and b24 of the piston 20 and the oil passages a35 and b35 of the piston cylinder 30.

As long as the compression pressure diffused into the piston cylinder 30 exists, the piston 20 is in the state in which the piston 20 compresses the brake disk 10 by the self-energizing action compressing the piston 20 toward the brake disk 10.

At this time, the passages a33 and b33 of the piston cylinder 30 are opened, and the compression pressure within the lower side cylinder 3 with reference to the piston 20 flows through the oil passage a51 formed in the holder 50, the passage a53, and the oil passage a33 formed in the piston cylinder 30, and is sucked into the upper side cylinder 3 with reference to the piston 20 where the vacuum pressure is formed together with the compression pressure within the piston cylinder 30 through the opened oil passage b33 and via the passage b53 of the holder 50 and the oil passage b51. Thus, the compression pressure that compresses the piston 20 is completely exhausted and the pressures of the upper side and lower side with reference to the piston 20 become 0.

As illustrated in FIG. 3, the ball bearing screw 20 connected to the forward coupling 260 of the piston drive motor 200 by the ECU program is rotated forward and the guide block 250 connected to the grip 240 by the grip threads 220 engaged with the drive screw threads 230 of the ball bearing screw 210 is moved toward the brake disk 10. In addition, the piston cylinder 30 connected to the guide block 250 is also moved in the same direction while cancelling out the resistance generated by the pressure difference of the oil generated when the piston cylinder 30 is moved through the oil passages a24 and b24 of the piston 20 and the oil passages a35 and b35 of the piston cylinder 30.

The piston 20 is also moved toward the brake disk 10 together with the piston cylinder 30 together with the piston cylinder 30 to compress the piston spring 22 so that the piston roller 21 comes into contact with the brake cylinder 10. Therefore, the piston 20 blocks the volume of the cylinder 3 between the vane a100 and b100, thereby conducting the stop braking (parking) function.

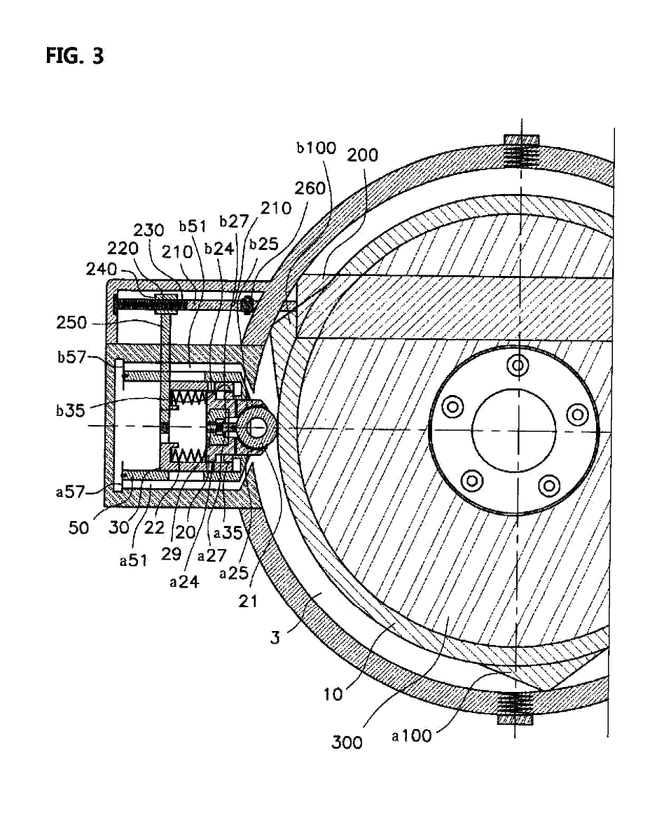

The operations when the piston roller comes into contact with the disk vanes will be described. As illustrated in FIG. 4, while the disk 10 is rotated clockwise, the braking function is conducted by the pressure by the volumetric reduction of the lower side cylinder 3 with reference to the piston 20.

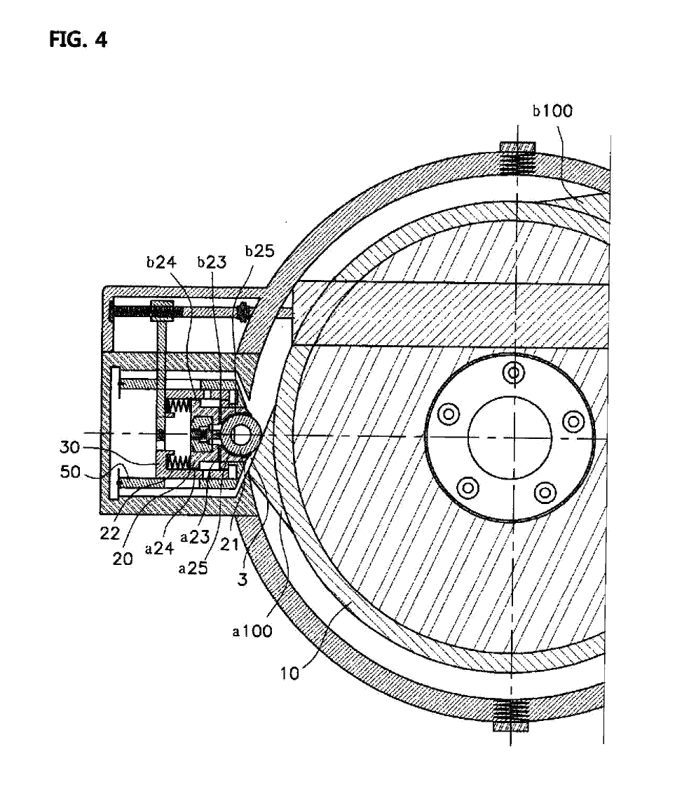

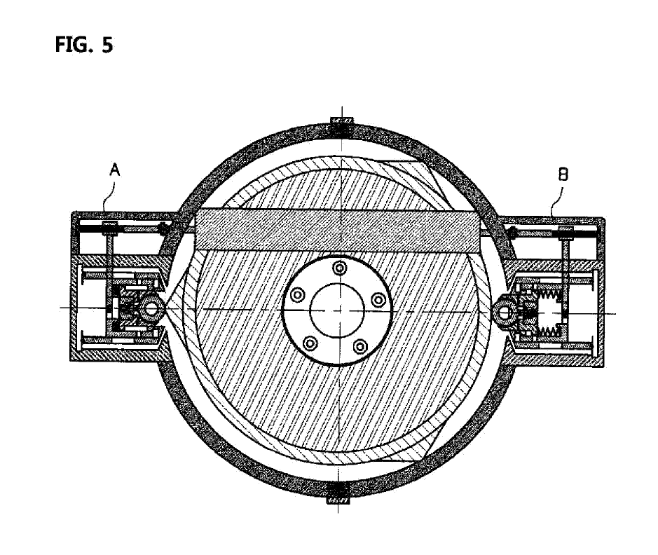

When the piston roller 21 is contacted with and moved on the vane a100, the piston 20 is moved toward the piston cylinder 30 while compressing the piston spring 22 by the pushing force of the vane a100. After the piston 20 passes a designated position, the bypass passages a23 and b23 of the piston 20 are opened, and the compression pressure within the lower side cylinder 3 with reference to the piston 20 the passages a33 and b33 of the piston cylinder 30 are opened, and the compression pressure within the lower side cylinder 3 with reference to the piston 20 is introduced into the piston cylinder 30 through the bypass passage a23 opened through the bypass passage a25 formed in the piston 20 and through the oil passage a24 and is sucked into the upper side cylinder 3 with reference to the piston 20 where the vacuum pressure is formed together with the compression pressure within the piston cylinder 30 through the oil passage b24, via the opened passage b23 and through the bypass passage b25, thereby cancelling out the pressure. Thus, as illustrated in FIG. 5, the braking function is temporarily lost. However, as illustrated in FIG. 6, when the brake disk 10 is rotated, the piston roller 21 is contacted with and rotated on the disk vane a100 by the restoration action of the piston spring 22. After the piston roller 21 passes the designated position, the bypass passages a23 and b23 formed in the piston 20 are blocked and the lower side disk vane c100 with reference to the piston 20 is moved toward the piston 20, thereby generating the compression resistance of oil to the extent of reducing the volume of the cylinder 3, and the upper side disk vane a100 with reference to the piston 20 is moved away from the piston 20 to increase the volume of the cylinder, thereby generating the vacuum resistance. As a result, the braking function is conducted again and the compression pressure within the lower side cylinder 3 with reference to the piston 20 is diffused into the piston cylinder 30 through the oil passage a51 formed in the holder 50 and via the check valve a57 in which the compression pressure which is proportional to the rotation speed and the volume change acts as a force for compressing the piston 20 toward the brake disk 10 and the vacuum pressure within the upper side cylinder 3 with reference to the piston 20 acts as a force for pulling the piston. As a result, even under an unstable external environment (e.g., an uneven road surface or the like) that applies vibration, impact or the like, the piston 20 is configured to compress the brake disk 10 by a self-energizing action as long as a pressure exists within the piston cylinder 30, thereby repeatedly performing the braking action based on the volume.

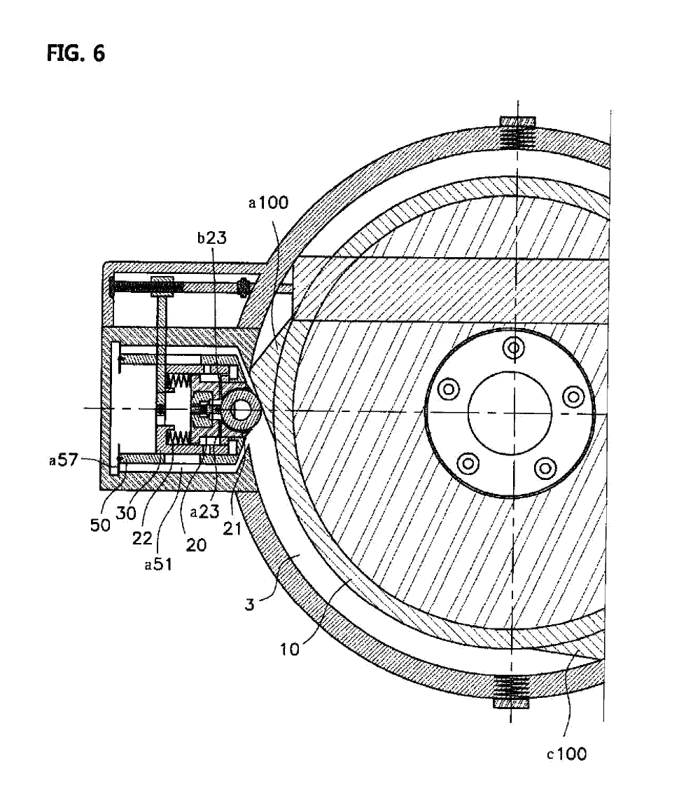

FIG. 7 is a cross-sectional view illustrating an electromagnetic valve drive type braking device which is another exemplary embodiment of the inventive braking device in which the piston cylinder 30 is moved by the magnetic force of an electromagnetic valve 200′ operated in a simple electrical ON/OFF method instead of the drive motor 200 to operate the braking device. The braking device may be preferably applied to a motor cycle, a bicycle, an electromotive machinery or the like.

In the other exemplary embodiment, the configurations of the piston and the piston cylinder are the same as those described above, FIGS. 1, 2, 3, 4 and 6 will be used below as the reference numerals of the components.

Referring to FIG. 7 that illustrates an electromagnetic valve drive type braking device as another configuration of the inventive braking device, in order to facilitate the movement of the piston cylinder 30 without using a large force for operating the electromagnetic valve 200′ when the piston cylinder 30 is moved toward the disk 10 by the magnetic force of the electromagnetic valve 200′ by operating the braking device (supplying electricity), the piston 20 is formed with oil passages a24 and b24 and the piston cylinder 30 is formed with oil passages a35 and b35 so that oil may be moved through the oil passages, thereby cancelling out the resistance by the pressure difference of oil occurring when the piston cylinder 30 is moved.

The piston 20 is also moved toward the disk 10 by the piston cylinder 30 and thus, compresses the piston spring 22, as illustrated in FIG. 3, so that the piston roller 21 is contacted to and moved on the brake disk 10, thereby developing a condition for generating the braking load. The lower side disk vane a100 with reference to the piston 20 is moved toward the piston 20 by the rotation of the brake disk 10, thereby generating oil compression resistance by the extent of reducing the volume of the cylinder. By the rotation of the brake disk 10, the upper side vane b100 with reference to the piston 20 is moved away from the piston 20 to increase the volume of the cylinder, thereby generating vacuum resistance.

In addition, the compression pressure within the lower side cylinder 3 with reference to the piston 20 is diffused to the inside of the piston cylinder 30 through the oil passage a51 configured in the holder 50 and via the check valve a57, and the compression pressure which is proportional to the rotation speed and the volume change acts as a force for compressing the piston 20 toward the brake disk 10, and the vacuum pressure within the upper side cylinder 3 with reference to the piston 20 acts as a force for pulling the piston 20. Accordingly, even under any unstable external environment that applies vibration, impact or the like, the piston 20 is configured to compress the brake disk 10 by a self-energizing action as long as a pressure exists within the piston cylinder 30, thereby performing its own function of the braking action based on the volume.

In addition, when the speed of the vehicle is high at the time of conducting the braking function, a higher pressure and a stronger braking force in proportion to the pressure occur in the cylinder 3. By applying respective data for preventing the damage of the braking device by the compression pressure and designing each vehicle model (speed, maximum load, inertia, use and the like) with a braking distance prediction program through simulation, the mechanical limit pressure within the cylinder 3 at the time of rapid braking is analyzed and data such as a tire locking phenomenon by inertia at the time of rapid braking for each speed are determined so as to analyze a proper pressure value within the cylinder for the most stable braking for each vehicle, thereby providing a pressure discharge valve 29 which is a braking pressure stabilization device in the piston 20.

In addition, the oil passing the bypass passages a25 and b25 of the piston 20 when conducting the braking function passes between the piston rollers 21 while performing lubrication and sealing actions so as to cancel out the frictional resistance generated on the piston rollers 21 due to the stress by the strong compression pressure.

The actions after completing the deceleration by the operation (supplying electricity) of the braking device will be described. If the driver stops a braking command by operating a braking switch (cutting off electricity) when the rotation force of the brake disk is reduced to a desired level or stopped by the compression/vacuum action according to the operation sequence, the piston cylinder 30 is also moved toward the holder 50 by the restoration action of the piston cylinder spring 32 while cancelling out the resistance caused by the pressure difference of oil generated when the piston cylinder is moved through the oil passages a24 and b24 of the piston 20 and the oil passages a35 and b35 of the piston cylinder 30.

As long as the compression pressure diffused into the piston cylinder 30 exists, the piston 20 is in the state in which the piston 20 compresses the brake disk 10 by the self-energizing action of compressing the piston 20 toward the brake disk 10.

At this time, the passages a33 and b33 of the piston cylinder 30 are opened, and the compression pressure within the lower side cylinder 3 with reference to the piston 20 flows through the oil passage a51 formed in the holder 50, the passage a53, and the opened oil passage a33 formed in the piston cylinder 30, and is sucked into the upper side cylinder 3 with reference to the piston 20 where the vacuum pressure is formed together with the compression pressure within the piston cylinder 30 through the opened oil passage b33 and via, the passage b53 of the holder 50 and the oil passage b51. Thus, the compression pressure that compresses the piston 20 is exhausted and the piston 20 is also returned to the holder 50 following the piston cylinder 20, thereby terminating the deceleration action.

Another exemplary embodiment of the present device may be applied to a hybrid or motor vehicle. When the hybrid or motor vehicle is stopped and then started while going on a hill, the weight of the vehicle body is increased in proportion to the slope of the road and applies a large load to the motor. Thus, a power of two or three times of the normally required power is required.

Due to this problem, it is inevitable to use a motor of a high capacity or to mount an auxiliary engine when designing a vehicle.

The inventive device is configured to use the motor coupled to the disk as a main power source, for example, when the vehicle is driven on a hill and provides disk vanes in a hydraulic or pneumatic pump motor so that the pump motor may be used as an auxiliary power device, for example, when the vehicle is driven on a hill and thus, requires power. As a result, the capacity of the main power device (motor) may be reduced and the auxiliary engine may be omitted when designing a vehicle.

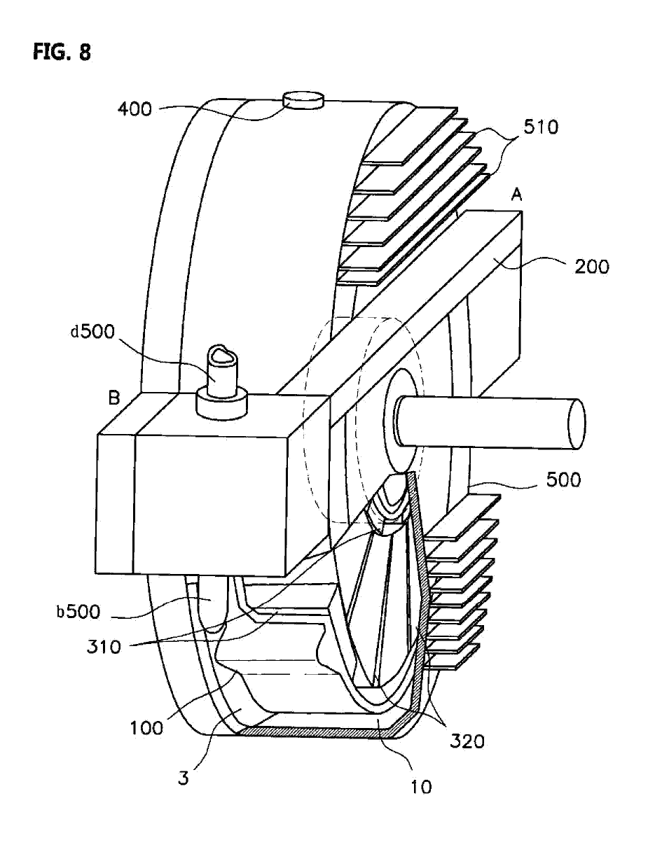

FIG. 9 is a cross-sectional view illustrating a volumetric braking and disk vane hydraulic motor integration type device as another exemplary body of the braking device in which hydraulic pressure (or pneumatic pressure) IN and Out lines and a control valve are added.

FIG. 9 is a cross-sectional view illustrating a state in which a hydraulic valve is cut off before the disk vane hydraulic motor is operated.

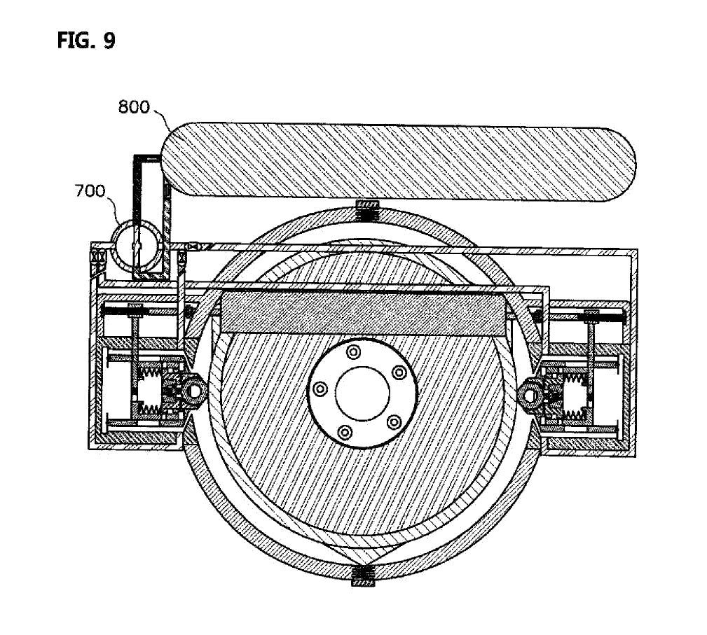

FIG. 10 is a cross-sectional view the hydraulic pump motor is operated and rotated clockwise.

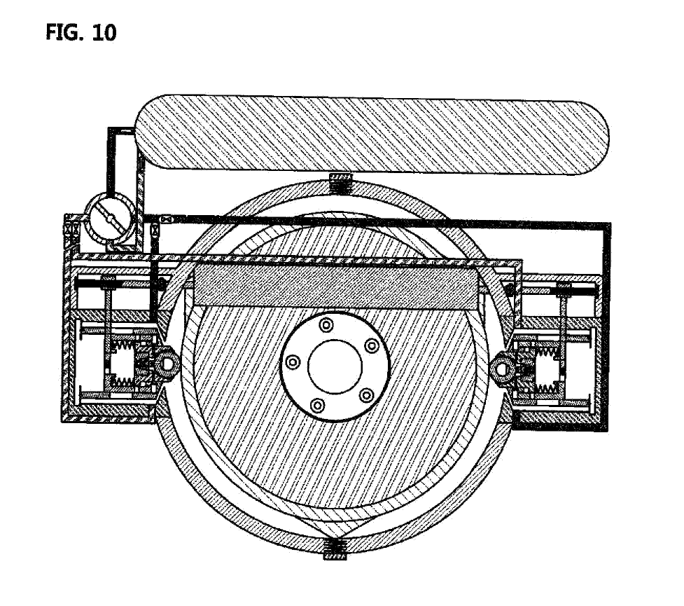

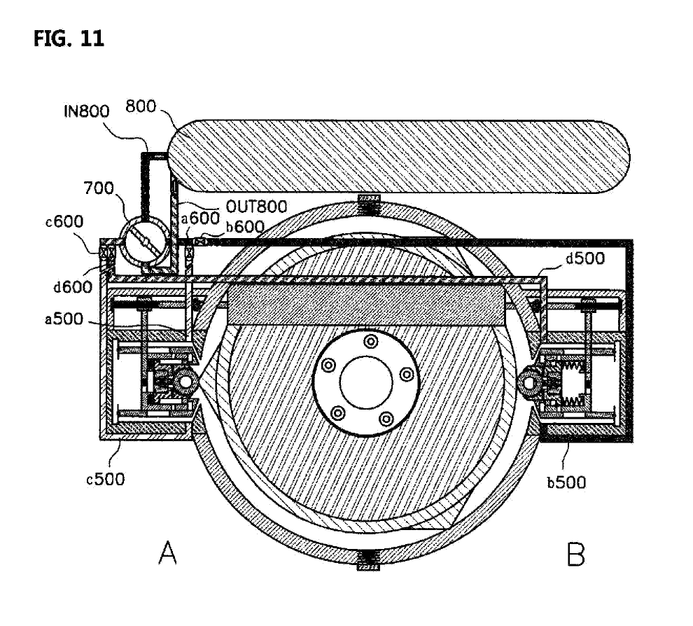

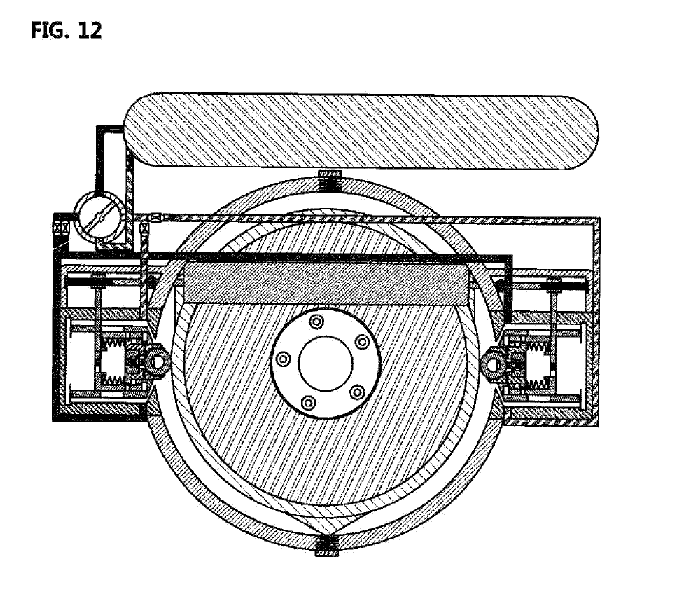

FIG. 11 is a cross-sectional view illustrating a state in which a hydraulic line is cut off when the hydraulic pump motor of the disk vane hydraulic motor integration type is operated and thus, the “A” piston roller is contacted with and moved on a vane, and FIG. 12 is as cross-sectional view illustrating the hydraulic pump motor of the disk vane hydraulic motor integration type which is operated and moved counterclockwise.

Here, the motor, the supply lines or the like is described with reference to hydraulic pressure. However, the device may be configured to be operated by pneumatic pressure rather than by hydraulic pressure.

A volumetric braking and disk vane hydraulic motor integration type braking device as another exemplary embodiment of the inventive braking device will be described with reference to FIG. 9. When the RPM of the main power motor drops a set value due to, for example, the lack of motor power (when being on a hill) while the vehicle is driven by operating the accelerator (acceleration pedal) or when the vehicle is started after being stopped, the ball bearing screw 20 connected to the forward coupling 260 of the piston drive motor 200 by the ECU program is rotated forward and the guide block 250 connected to the grip 240 by the grip threads 220 engaged with the drive screw threads 230 of the ball bearing screw 210 is moved toward the brake disk 10. In addition, the piston cylinder 30 connected to the guide block 250 is also moved in the same direction while cancelling out the resistance generated by the pressure difference of the oil generated when the piston cylinder 30 is moved through the oil passages a24 and b24 of the piston 20 and the oil passages a35 and b35 of the piston cylinder 30.

The piston 20 is also moved toward the brake disk 10 together with the piston cylinder 30 to compress the piston spring 22 so that the piston roller 21 comes into contact with the brake cylinder 10. Therefore, the piston 20 blocks the volume of the cylinder 3 between the vane a100 and b100, thereby developing a condition for using the vanes as an auxiliary power device.

Here, a feature different from the braking function is as follows. As can be seen from FIG. 10, since a switch valve 700 is opened to the forward direction, the hydraulic pressure of a tank 800 is introduced through the supply line (IN800). At the same time, the hydraulic pressure is introduced through the lines when a solenoid a600 of a hydraulic line a500 provided in the holder 50 of the “A” piston 20 side and a solenoid b600 of a hydraulic line b500 provided in the holder 50 of the “B” piston 20 side are opened. The hydraulic pressure introduced into the upper side cylinder 3 with reference to the “A” piston 20 and the lower side cylinder 3 with reference to the “B” piston 20 compress the vane b100 and the vane a100, thereby rotating the disk 10 by the hydraulic force, and a part of the hydraulic pressure is introduced into the cylinder 30 via the check valve 57 to compress the piston, thereby stably rotating the disk 10.

In addition, unlike the braking function, in order to prevent the pressure of the oil in the lower side cylinder 3 with reference to the “A” piston and the upper side cylinder 3 with reference to the “B” piston 20 which is generated by the rotation of the disk 10 by the hydraulic pressure from acting as a resistance pressure, the solenoid c600 of the hydraulic line c500 formed in the holder 50 of the “A” piston 20 side and the solenoid d600 of the hydraulic line d500 formed in the holder 50 of the “B” piston 20 side are opened so that the oil is introduced into the tank 800 via the switch valve 700 and through the hydraulic pressure recovery line OUT800.

The hydraulic pressure of the tank 800 is sensed through a pressure sensor by the ECU program, when the hydraulic pressure lower than the set pressure is sensed, a hydraulic pump which is separately configured is operated so that the pressure is always maintained constantly.

Here, the hydraulic pump may be constituted with an electric motor, a pneumatic motor or a compact engine (internal-combustion engine).

When the braking function is conducted again (FIG. 9), the solenoid c600 of the hydraulic line c500 configured in the holder 50 of the “A” piston 20 side and the solenoid d600 of the hydraulic line d500 configured in the holder 50 of the “B” piston 20 side, the solenoid a600 of the hydraulic line a500 configured in the holder 50 of the “A” piston 20 side and the solenoid b600 of the hydraulic line b500 configured in the holder 50 of the “B” piston 20 side, and the switch valve 700 are sequentially blocked by the ECU program.

When the piston roller 21 is contacted with and moved on the vane a100 while the disk is rotated clockwise, the piston 20 is moved toward the piston cylinder 30 while compressing the piston spring 22 by the pushing force of the vane a100. When passing a designed position, by the ECU program, with the sensing of the wheel position sensor, the solenoid c600 of the hydraulic line c500 configured in the holder 50 of the “A” piston side and the solenoid a600 of the hydraulic line a500 configured in the holder 50 of the “A” piston side are blocked, thereby preventing the leakage of the hydraulic pressure. In addition, like the operation of the braking device, the bypass passages a23, b23 of the piston are opened, the bypass passages a23 and b23 of the piston 20 are opened, and the compression pressure within the lower side cylinder 3 with reference to the piston 20 is introduced into the piston cylinder 30 through the bypass passage a23 opened through the bypass Passage a25 formed in the piston 20 and through the oil passage a24 and is sucked into the upper side cylinder 3 with reference to the piston 20 where the vacuum pressure is formed together with the compression pressure within the piston cylinder 30 through the oil passage b24, via the opened passage b23 and through the bypass passage b25, thereby cancelling out the pressure. Thus, as illustrated in FIG. 5, the braking function is temporarily lost (at this time, the “B” piston 20 at the opposite side may continuously perform the hydraulic motor function in construction while it is rotated by 360 degrees by maintaining the operation the hydraulic motor). After the piston roller 21 is contacted with and moved on the disk vane a100 by the restoration action of the piston spring 22 by the rotation of the disk 10, the bypass passages a23 and b23 configured in the piston 20 are blocked and by the ECU program and based on the sensing of the wheel position sensor, the solenoid c600 of the hydraulic line c500 and the solenoid a600 of the hydraulic line a600 which are configured in the holder 50 of the “A” piston 20 side are opened so that the hydraulic pressure of the tank 800 compresses the upper side disk vane a100 with reference to the “A” piston 20 again, thereby rotating the disk 10 and a part of the hydraulic pressure is introduced into the cylinder 30 via the check valve 57, thereby compressing the piston, thereby stably rotating the disk 10.

As described above, since the inventive braking device transfers an operation command as an electrical signal by a sensor (switch), the rapid response braking function of the braking device may be digitalized by program input.

In addition, various sensors (for example, a wheel speed sensor, a handle rotation angle sensor, a front object distance sensing sensor, a slope sensor, a weight balance sensing sensor, an external air temperature sensing sensor or the like) may be used so as to incorporate an artificial intelligence function to the ECU (an alarm function by the distance sensing sensor, an automatic deceleration and braking function at the time of approaching, a braking device check alarm function when braking is performed exceeding the braking device operation stop time by the wheel speed sensor and program analyzed setting time, or the like).

In addition, since data of various kinds of vehicles may be input and used by a program, a single model braking device may be applied to various kinds of vehicles and thus, the compatible range is wide.

The inventive braking device may be applied to braking all kind of rotating bodies that may use electricity, vehicles, trains, airplanes, motor cycles, various driving machinery, etc.

### INDUSTRIAL APPLICABILITY

The present invention may solve the problems of the existing braking devices (hydraulic type and friction type) including environmental problems such as dust caused due to frictional abrasion, high temperature deterioration, noise generation, weak braking force, pollution due to scattering of asbestos, metal or the like, and periodic replacement due to wear and tear by configuring a braking device in a volumetric type using a volume change and may obtain an environment-friendly effect by increasing the life of the braking device.

1. A volumetric braking device comprising:
a brake disk having an outer surface on which a plurality of disk vanes are formed with a predetermined spacing therebetween;
a cylinder case in which the brake disk is arranged, and the internal space of a cylinder is sectioned into a plurality of spaces by means of the disk vanes;
a piston drive unit, which has a piston roller sliding on the brake disk, and in which the compressed pressure resistance generated between the piston roller and any one disk vane and vacuum pressure resistance generated between the piston roller and another disk vane operate as a braking load for the brake disk to perform decelerating and braking operations;
a drive motor, which receives an electrical signal from an ECU by means of a program in order to operate in a forward or reverse direction; and
a drive unit operating module for operating the piston-drive unit by operating the drive motor.

2. The volumetric braking device as claimed in claim 1, wherein the piston drive unit comprises:
a piston cylinder moved by the operation of the drive motor;
a piston installed in front of the piston cylinder and moved by and together with the piston cylinder;
a piston roller interposed in front of the piston and contacted with and moved on the brake disk so as to generate the braking load;
a piston spring mounted between the piston cylinder and the piston to elastically support the piston;
a casing coupled to the cylinder case and configured to accommodate the above-described components; and
a holder installed inside of the casing in such a manner that an oil passage is formed between the holder and the casing.

3. The volumetric braking device as claimed in claim 1, wherein the piston drive unit is installed on each side of the cylinder case so that, when the piston drive units are operated by the drive motor, two piston rollers are contacted with and moved on the brake disk and the disk vanes, thereby generating the braking load by the volume change.

4. The volumetric braking device as claimed in claim 1, wherein each of the disk vanes is formed in a triangle shape having a smooth curve in relation to the brake disk so that the piston roller may be smoothly rotated without receiving resistance.

5. The volumetric braking device as claimed in claim 1, wherein three disk vanes are arranged at a 120 degree interval on the outer circumference of the brake disk in order to prevent the brake disk from becoming eccentric when rotating.

6. The volumetric braking device as claimed in claim 1, wherein the filler within the cylinder case is configured by any one selected from an incompressible oil, various gases and a combination thereof.

7. The volumetric braking device as claimed in claim 1, wherein the piston drive unit is provided with a pressure discharge valve configured to bypass a pressure over a limit pressure so as to prevent the damage of the braking device.

8. The volumetric braking device as claimed in claim 7, wherein a check valve is installed between the pressure discharge valve and the piston roller, and the charge which has passed the check valve is bypassed after it is introduced into the cylinder where a vacuum pressure is formed through the bypass passage

9. The volumetric braking device as claimed in claim 2, wherein the oil passage formed between the casing and the holder is provided with a check valve so as to prevent the oil introduced into the oil passage from flowing backward.

10. The volumetric braking device as claimed in claim 1, further comprising a disk motor which is coupled to the brake disk and may be used as a main power device, or an auxiliary power device.

11. The volumetric braking device as claimed in claim 10, wherein the disk motor has a rotator constituted by a coreless motor and a stator configured in the cylinder case.

12. The volumetric bearing device as claimed in claim 1, wherein the cylinder case is provided with an inlet configured to introduce a filler into the cylinder.

13. The volumetric braking device as claimed in claim 1, wherein the drive unit operating module comprises:
a ball bearing screw connected to the motor shaft of the drive motor and a coupling;
a grip formed with grip threads engaged with drive threads of the ball bearing screw; and
a guide block connected with the grip to be linearly moved.

14. The volumetric motor as claimed in claim 2, wherein the piston is formed with an oil passage and the piston cylinder is formed with an oil passage so as to facilitate the movement of the piston cylinder without using a large force for operating the driving motor when moving the piston cylinder.

15. The volumetric motor as claimed in claim 1, further comprising:
a tank configured to supply hydraulic pressure or pneumatic pressure;
a supply line through which the hydraulic pressure or the pneumatic pressure is supplied so as to rotate the brake disk; and
a switch valve configured to open/close the supply line.

16. A volumetric braking device comprising:
a brake disk having an outer surface on which a plurality of disk vanes are formed with a predetermined spacing therebetween;
a cylinder case in which the brake disk is arranged, and the internal space of a cylinder is sectioned into a plurality of spaces by means of the disk vanes;
a piston drive unit, which has a piston roller sliding on the brake disk, and in which the compressed pressure resistance generated between the piston roller and any one disk vane and vacuum pressure resistance generated between the piston roller and another disk vane operate as a braking load for the brake disk to perform decelerating and braking operations; and
an electromagnetic valve configured to move the piston cylinder of the piston drive unit.

17. The volumetric braking device as claimed in claim 16, wherein the piston drive unit comprises:
a piston cylinder moved by the operation of the electromagnetic valve;
a piston installed in front of the piston cylinder and moved by and together with the piston cylinder;
a piston roller interposed in front of the piston and contacted with and moved on the brake disk so as to generate the braking load;
a piston spring mounted between the piston cylinder and the piston to elastically support the piston;
a casing coupled to the cylinder case and configured to accommodate the above-described components; and
a holder installed inside of the casing in such a manner that an oil passage is formed between the holder and the casing.

18. The volumetric braking device as claimed in claim 2, wherein the piston drive unit is installed on each side of the cylinder case so that, when the piston drive units are operated by the drive motor, two piston rollers are contacted with and moved on the brake disk and the disk vanes, thereby generating the braking load by the volume change.

19. The volumetric braking device as claimed in claim 4, wherein three disk vanes are arranged at a 120 degree interval on the outer circumference of the brake disk in order to prevent the brake disk from becoming eccentric when rotating.

20. The volumetric motor as claimed in claim 2, further comprising:
a tank configured to supply hydraulic pressure or pneumatic pressure;
a supply line through which the hydraulic pressure or the pneumatic pressure is supplied so as to rotate the brake disk; and
a switch valve configured to open/close the supply line.
